(19) United States
(12) Patent Application Publication
(10) Pub. No.: US 2024/0116590 A1
(43) Pub. Date: Apr. 11, 2024

(54) SENSOR ARRANGEMENTS

(71) Applicant: BODY ROCKET LTD, Heywards Heath, Sussex (GB)

(72) Inventors: Eric Charles Degolier, Heywards Heath (GB); Jordan Bolland, Brighton (GB)

(21) Appl. No.: 18/269,047

(22) PCT Filed: Dec. 21, 2021
(86) PCT No.: PCT/GB2021/053383

§ 371 Date: Jun. 22, 2023

(30) Foreign Application Priority Data
Dec. 22, 2020 (GB) 2020349.3

(51) Int. Cl. B62J 45/41; B62J 45/42

(52) U.S. Cl. CPC B62J 45/41; B62J 45/42

(57) ABSTRACT

A device adapted to be retrofitted between extant parts of a bicycle. The device comprises a sensor for measuring forces in a substantially horizontal plane and weight forces in a substantially vertical plane. The device further comprises engagement means for connecting the device to the extant parts.

### FIELD OF THE INVENTION

The present inventive concept generally relates to sensor arrangements for vehicles, especially but not limited to vehicles where the user is exposed to the wind, i.e. push, bicycles.

### BACKGROUND TO THE INVENTION

A previous patent application, published as WO 2011/138590 addressed methods of real-time calculation of total longitudinal force and aerodynamic drag acting on a rider on a vehicle.

That patent application addressed the methodology and computational issues of calculating in substantially real time the drag acting on a rider of, for example, a bicycle. Thus, the rider can respond to that calculation so as to improve his or her technique to improve performance.

There is very little history of aerodynamic drag force measurement being integrated into a moving vehicle, and previous attempts have been custom installations that were costly and required a high level of technical skill (Rider/Motorcycle Interaction—a Human Approach to Motorcycle Safety—Funke, 2001). Lab based measures of forces have not attempted to measure drag, and relied on similar bespoke systems that were costly and required a high level of skill to create (Measurement of Rider Induced Loads During Simulated Bicycling—Bolourchi, 1985). A sensor that is retrofittable to standard mounting points of the vehicle, such that they are in the load path of the forces of interest, significantly reduces the cost and complexity of the system.

The present application addresses related aspects.

### SUMMARY OF INVENTION

Some aspects according to the invention are defined in the claims. Additional aspects according to the invention are defined as follows:

An aspect of the present inventive concept provides a vehicle of known type, characterised in that the vehicle comprises one or more sensors retrofitted between extant parts of the vehicle. By retrofitted we mean that the sensors may be fitted to existing parts of the vehicle (i.e. mounts).

Placing a sensor directly in the load path as forces pass from, for example, the rider to the bicycle frame, enables their measurement.

Extant parts may be, for example, the seat post and saddle of a bicycle. Thus, a sensor would be retrofitted to be located between the seat post and the saddle of an extant bicycle. Advantageously therefore the sensor may be fitted to existing bicycles after purchase.

On a standard bicycle the saddle/seat post connection is made at a set of 7 mm rails, though an oval 7×9 mm profile and a few non-standard 7×9.5 or 7×10 mm profiles exist. Non-round rails tend to be used for high-end saddles that use carbon fibre rails. The present inventive concepts can be used with all the aforementioned configurations.

In a broad independent aspect there is provided a device comprising a sensor and an engagement means, the engagement means being adapted to engage a portion of a seat post for a bicycle, and further adapted to engage the seat/saddle of the bicycle. In other words, the sensor has attachments (the engagement means) which may be retrofitted, for example, between a rail (or a plurality/set of rails) of the bicycle. The device may also be thought of as a force measuring (sensing) device.

In a dependent aspect, the device further comprises one or more rails adapted to engage the seat post.

In a dependent aspect, the device further comprises a clamp adapted to engage one or more rails of the bicycle saddle.

In a dependent aspect, the device further comprises an enclosure within which the sensor is arranged.

Alternatively, the engagement means is adapted to engage a portion of a bicycle frame.

In another independent aspect, a device comprises an enclosure within which a sensor is arranged, wherein the enclosure comprises means for attachment to a set of extant rails and comprises a set of rails adapted to engage a bicycle seat.

In another independent aspect, a device comprises a seat post portion adapted to engage a bicycle frame, an enclosure within which a sensor is arranged, and a clamp adapted to engage a rail of the bicycle saddle, wherein the seat post, and sensor are formed integrally.

In another independent aspect, a device comprises a portion of a handlebar stem adapted to engage a bicycle steerer, an enclosure within which a sensor is arranged, and an engagement means adapted to engage a set of bicycle handlebars.

This aspect is intended to accommodate standard road bikes and mid-range triathlon bikes, for example. Thus the sensor is integrated into a stem portion, which has standard 32.8 mm diameter clamps to attach to both the bike steerer tube and the handlebar. Thus the stem of a bike may be replaced with a stem incorporating the features of the present inventive concept or be retrofitted to incorporate them.

In another independent aspect, a device comprises a first engagement means adapted to engage a set of bicycle handlebars, an enclosure within which a sensor is arranged, and a second engagement means adapted to engage a handlebar extension. Handlebar extensions are sometimes referred to as “aero extensions” “aero bars” or similar.

Some high-end bicycles have integrated stem/handlebar systems, including mounting points for aero extensions to attach to. One embodiment envisaged is an aftermarket product (or supplied as part of the bicycle) comprising an adapter bracket adapted to engage with existing mount points, allowing a sensor to fit in between the aero extensions and the base bar.

A further independent aspect provides a sensor suitable for retrofit attachment to a vehicle of known type, characterised in that the sensor is adapted to measure mechanical forces in substantially the horizontal plane and the vertical plane, and, optionally, moments around two orthogonal axes in the horizontal plane (x and z axes). Advantageously, the sensor may be fitted on existing bicycles for example. The mechanical forces may be horizontal drag forces and vertical weight forces, respectively.

Preferably, the sensor is further adapted to measure an angle between the sensor and the substantive horizontal plane. In other words, the sensor is thus adapted to measure any inclination of the sensor itself from the horizontal. Such an inclination may result from the positioning of the sensor itself with respect to the vehicle, or a temporary inclination of the vehicle itself during transit, or a combination thereof.

The measurement of inclination is important. For example, a rider can weigh 100 kg but may only generate 1 kg of drag force. If monitoring to 2% accuracy is desired (20 g), the trigonometry implies an inclination error of 0.01 degrees results in rider weight causing an error of 17 g in the measurement of drag force.

With increased sensitivity ratios as described above, the angle of inclination of the load cell becomes important.

Preferably, the sensor comprises a substantially flat surface which is provided with an integral angle measurement device. Thus the angle of inclination of the sensor can be ascertained.

A further aspect of the present inventive concept provides a vehicle of known type according to the first aspect, characterised in that the one or more sensors are according to any of the aspects described above.

A further independent aspect provides an adaptor comprising an engagement means adapted to engage a portion of a handlebar system and a sensor to thereby retrofit the sensor into the load path of the handlebar system.

In a preferred independent aspect there is provided a force measuring device for connection between extant part of a vehicle of known type such as a bicycle, the device adapted to measure horizontal drag forces and vertical weight forces, the device comprising a sensor, and attachment means for connection to a first extant part of the bicycle (such as a seat post) and for further connection to a second extant part of the bicycle to which a user may apply a force (such as a saddle or handlebars).

Advantageously, the force measuring device may be retrofitted directly in the load path as forces pass from, for example, the rider to the bicycle frame. Optionally, the sensor may be provided in an enclosure of the device. Optionally, the sensor may be further adapted to measure an angle between the sensor and the substantive horizontal plane.

It will be appreciated that combinations are possible between the above mentioned aspects.

### DETAILED DESCRIPTION OF THE INVENTION

Exemplary embodiments of the device according to the invention will now be described in reference to the accompanying drawings, in which:

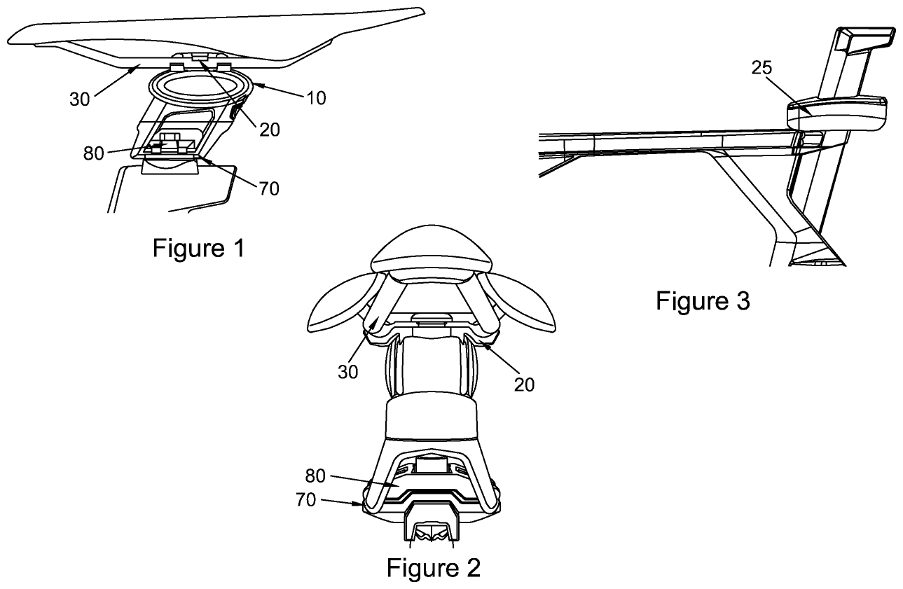

FIG. 1 illustrates positioning a sensor using standard mounting points of a bicycle seat post and saddle using a rail clamp mechanism;

FIG. 2 is another schematic view of the rail-clamp mechanism for positioning a sensor between standard mounting points of a seat post and saddle;

FIG. 3 illustrates the mounting of a sensor between the bicycle frame and seat post;

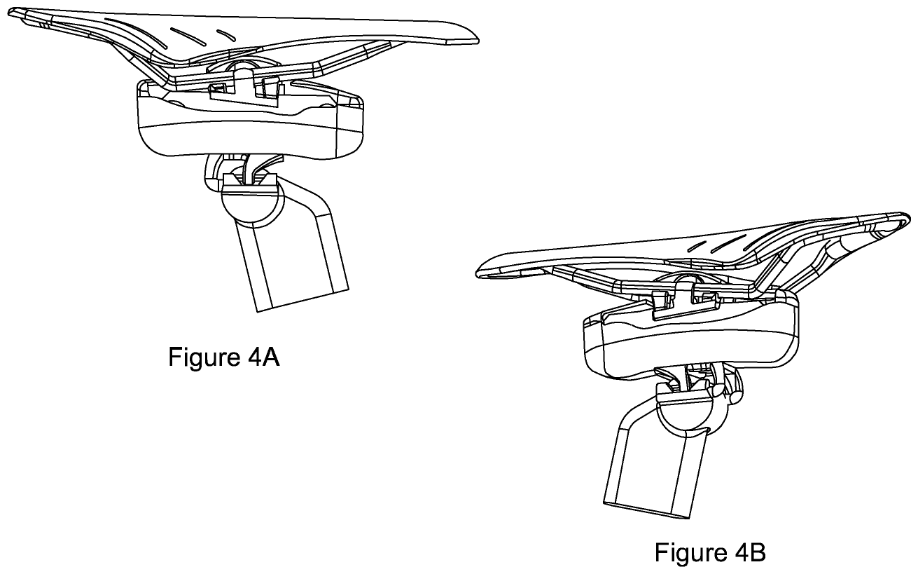

FIGS. 4A and 4B illustrate further examples of positioning a sensor using standard mounting points of a bicycle saddle;

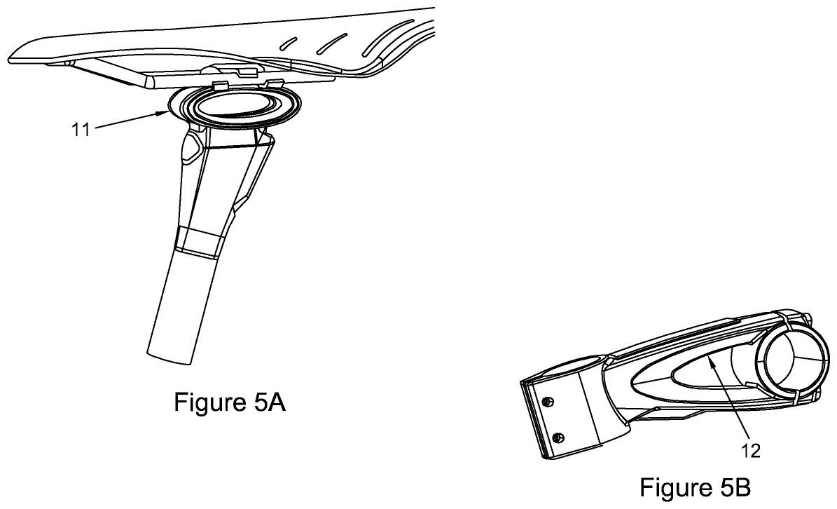

FIG. 5A illustrates a sensor integrated into the seat post;

FIG. 5B illustrates a sensor integrated into a stem;

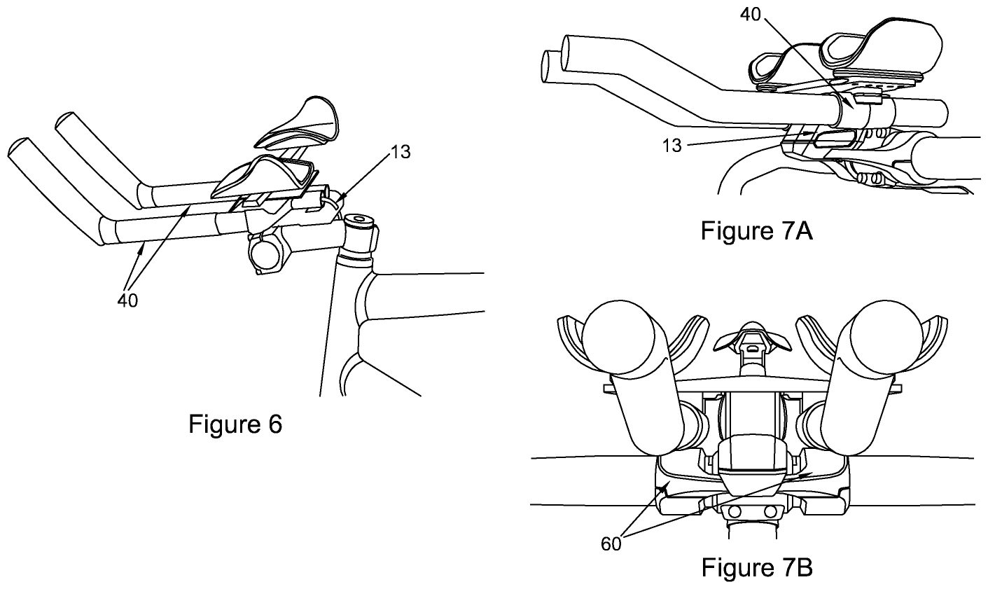

FIG. 6 shows a sensor mounted between a handlebar stem and aero extensions;

FIGS. 7A and 7B show clamping a sensor to a base bar instead of the stem; and

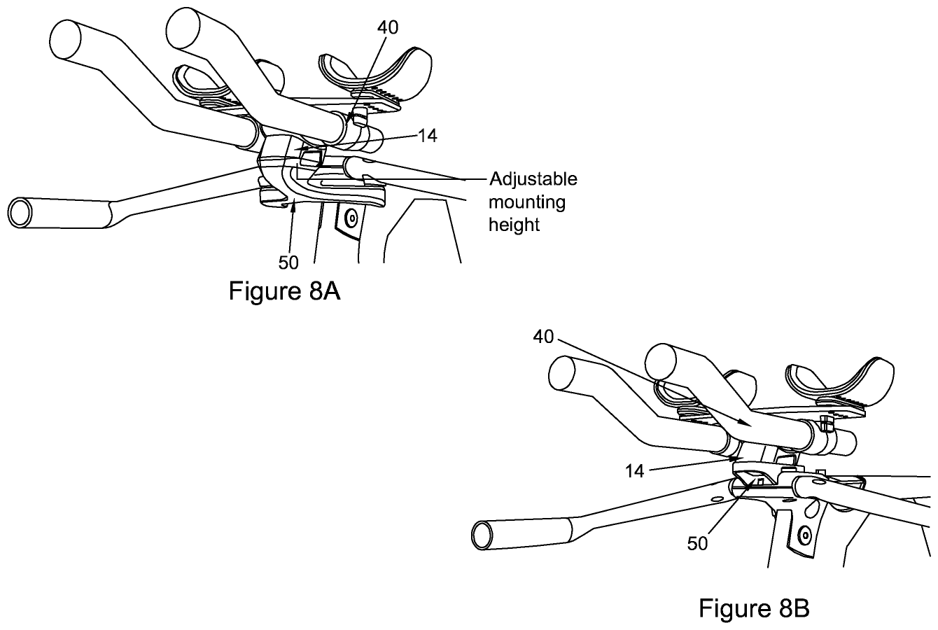

FIGS. 8A and 8B show adaptor brackets that mate with existing mount points, allowing a sensor to fit in between the aero extensions and the base bar of a bicycle.

Embodiments of the present invention relate to placing a sensor between standard parts on a bicycle. The areas of most interest are the seat post/saddle connection and the handlebar or stem and aerobar extension connection. The sensor may also be located between a steerer and handlebars of the bicycle, or frame and seat post to achieve a similar measurement. Advantageously, placing the sensor directly in the load path as forces pass from the rider to the bike frame is essential to their measurement.

FIG. 1 illustrates positioning a sensor 10 using standard mounting points of a bicycle saddle.

The sensor 10 preferably takes four measurements. Forces along the horizontal and vertical, and moments around the x (horizontal) and z axis (coming out of the page in the side view of a bike). The measurement of these forces is necessary to resolve drag forces. Additionally, the inclination of the sensor is extremely important. For example, a rider can weigh 100 kg but may only generate 1 kg of drag force, which should be monitored to 2% accuracy (20 g) to provide a valuable metric. An inclination error of 0.01 degrees results in rider weight causing an error of 17 g.

FIG. 2 is another schematic view of the rail-clamp mechanism 20 for clamping on saddle rails 30 and the rail 70 that mates with the clamp 80 of the bicycle seat post. On a standard bike the saddle/seat post connection is made at a set of 7 mm rails, though an oval 7×9 mm profile and a few non-standard 7×9.5 or 7×10 mm profiles exist. Non-round rails are typically used for high-end saddles that use carbon fibre rails.

FIG. 3 shows an alternative for a sensor mounting point where the seat post meets the bicycle frame.

FIGS. 4A and 4B illustrate further examples of positioning a sensor using standard mounting points of a bicycle saddle.

FIG. 5A illustrates a sensor 11 integrated into the seat post. FIG. 5B illustrates a sensor 12 integrated into a stem. This is advantageous to accommodate standard road bikes and mid-range triathlon bikes for example the stem in this case has standard 32.8 mm diameter clamps to attach to both the bike steerer tube and the handlebar.

Bicycle handlebars have a common diameter to clamp to, as do bicycle stems, and aero extensions. Where the extensions would normally clamp to the handlebar or stem, a sensor may be attached either between handlebar and extension, or between the stem and extension.

FIG. 6 shows a sensor 13 mounted between a handlebar stem and aero extensions 40. To isolate the aero extensions from the rest of the bike it is possible to provide a standard stem that allows mounting of the sensor 13 on top of the stem.

Similarly, it is possible to clamp to the base bar instead of the stem. This allows a rider to use a stem of any length and rise angle, and is a common place for the aero extensions to mount on a mid-range triathlon or racing bicycle. FIGS. 7A and 7B show clamping a sensor with two clamps 60 to a base bar instead of the stem.

High-end bikes have integrated stem/handlebar systems, including mounting points for the aero extensions to attach to FIG. 8A shows an adaptor, referred to as a bracket 50, that mates with existing mount points, allowing a sensor 14 to fit in between the aero extensions 40 and the base bar of a bicycle.

FIG. 8B shows an adapter for another style of integrated stem/handlebar system that utilizes a single-riser connection between the base bar and the extension.

1. A device adapted to be retrofitted between extant parts of a bicycle, the device comprising a sensor for measuring forces in a substantially horizontal plane and weight forces in a substantially vertical plane, the device further comprising an engagement unit for connecting the device to the extant parts, wherein the engagement unit is adapted to engage a portion of a seat post for a bicycle, and further adapted to engage a saddle of the bicycle, wherein the engagement unit comprises a clamp adapted to engage the bicycle saddle.

2.-3. (canceled)

4. A device according to claim 1, further comprising one or more rails adapted to engage the seat post.

5. A device according to claim 1, the device further comprises an enclosure within which the sensor is arranged.

6. (canceled)

7. A device according to claim 1, wherein the sensor is further adapted to measure an angle between the sensor and the substantially horizontal plane.

8. A device according to claim 1, wherein the sensor comprises a substantially flat surface, which is provided with an integral angle measurement device.

9. A device according to claim 1, wherein the device is configured to be retrofitted into a load path.

10. (canceled)

11. A bicycle frame comprising a device according to claim 1.

12. A bicycle comprising a device according to claim 1.

13. (canceled)

14. A device according to claim 15, wherein the sensor is integrated into the portion of the handlebar stem.

15. A device comprising:
a. a first engagement unit adapted to engage the set of bicycle handlebars; and
b. a second engagement unit adapted to engage a handlebar extension.

16. A force-measuring device for connection between extant part of a vehicle, the device adapted to measure horizontal drag forces and vertical weight forces, the device comprising:
a. a sensor; and
b. an attachment means for connection to a first extant part of the vehicle and for further connection to a second extant part of the vehicle to which a user may apply a force, wherein the attachment means is adapted to engage a portion of a seat post for a bicycle, and further adapted to engage a saddle of the bicycle, wherein the attachment means comprises a clamp adapted to engage the bicycle saddle.

17. A force-measuring device according to claim 16, configured to be retrofitted into a load path.

18. A force-measuring device according to claim 16, wherein the sensor is adapted to measure an angle between the sensor and a substantially horizontal plane.

19. A vehicle comprising a force measuring device according to claim 16.

20. A vehicle according to claim 19, wherein the vehicle is a bicycle.
